(19) United States
(12) Patent Application Publication
(10) Pub. No.: US 2006/0143016 A1
(43) Pub. Date: Jun. 29, 2006

(54) Method to access and use an integrated web site in a mobile environment

(75) Inventors: Courtney P. Jones, Ft. Myers, FL (US); Michael R. Roe, Vilas, NC (US)

Correspondence Address: HAHN LOESER & PARKS, LLP, One GOJO Plaza, Suite 300, AKRON, OH, 44311-1076, US

(73) Assignee: Blu Ventures, LLC and ioMedia Partners, LLC

(21) Appl. No.: 11/182,732

(22) Filed: Jul. 15, 2005

Related U.S. Application Data
(60) Provisional application No. 60/588,565, filed on Jul. 16, 2004.
(60) Provisional application No. 60/588,934, filed on Jul. 16, 2004.
(60) Provisional application No. 60/588,568, filed on Jul. 16, 2004.
(60) Provisional application No. 60/588,567, filed on Jul. 16, 2004.
(60) Provisional application No. 60/588,566, filed on Jul. 16, 2004.

(51) Int. Cl. G10L 11/00

(52) U.S. Cl. 704/270.1

(57) ABSTRACT

A method to access and use an integrated web site from a mobile environment is disclosed. The method includes communicating voice activated commands, using voice recognition technology, to an integrated web site via a wireless communication network and a global informational network. The integrated web site comprises a network-based media station integrated with a global search engine. The voice activated commands are used to access the integrated web site, initiate the transmission of streaming digital media content from the media station to a wireless mobile network terminal, and perform key word searches of the global informational network using the global search engine.

### CROSS-REFERENCE TO RELATED APPLICATIONS/INCORPORATION BY REFERENCE

This application claims priority to the following U.S. patent applications:

U.S. patent application Ser. No. 10/664,407, entitled “A Method for Operating an Internet Broadcasting Station” filed on Sep. 19, 2003, which is incorporated herein by reference in its entirety.

U.S. provisional patent application Ser. No. 60/547,765 filed Feb. 25, 2004 and U.S. patent application Ser. No. 11/066,623 filed Feb. 25, 2005, both entitled “Methods to Adapt Search Results Provided by an Integrated Network-Based Media/Search Engine Based on User Lifestyle”, both of which are incorporated herein by reference in their entirety.

U.S. Provisional Patent Application Ser. No. 60/588,934, entitled “Methods to Adapt Search Results Provided by an Integrated Network-Based Media Station/Search Engine Based on User Lifestyle” filed Jul. 16, 2004, which is incorporated herein by reference in its entirety.

U.S. Provisional Patent Application Ser. No. 60/588,565, entitled “A Method to Access and Use an Integrated Web Site in a Mobile Environment” filed Jul. 16, 2004, which is incorporated herein by reference in its entirety.

U.S. Provisional Patent Application Ser. No. 60/588,568, entitled “A Method to Generate Revenue for a Global Informational Network-Based Media Provider” filed Jul. 16, 2004, which is incorporated herein by reference in its entirety.

U.S. Provisional Patent Application Ser. No. 60/588,566, entitled “Systems and Methods to Provide Internet Search/Play Media Services” filed on Jul. 16, 2004, which is incorporated herein by reference in its entirety.

U.S. Provisional Patent Application Ser. No. 60/588,567, entitled “Method to Promote Branded Products and/or Services” filed on Jul. 16, 2004, which is incorporated herein by reference in its entirety.

### TECHNICAL FIELD

Certain embodiments of the present invention relate to searching and media program broadcasting. More particularly, certain embodiments of the present invention relate to a method to access and use, from a mobile environment, an integrated web site comprising a network-based media station integrated with a global search engine.

### BACKGROUND OF THE INVENTION

Traditional broadcasting, such as radio or television, combines programming content (such as entertainment content or news content) with commercial advertising content. Programming content is periodically interrupted by commercial advertising content in units of, typically, 30 seconds and 60 seconds to generate income for the broadcasting station and provide brand recognition for advertisers. A user of the broadcast is forced to wait until the commercial advertising segment is finished before he is able to resume consumption of programming content.

Public broadcasting, such as public radio or TV, typically depends upon corporate or foundation sponsors to generate income. The name of the sponsor associated with a certain programming content is often mentioned at the end of the broadcast of the sponsored program. Also, pleas for donations, in the form of on-air pledge drives, are made to users of public broadcasting to offset the cost of providing programming content. These pledge drives often interrupt programming content for extended periods of time.

On the Internet, search engines are used to find sources of information, media content, and advertisers. Advertisers pay the provider of the search engine to be found and are ranked according to bid, with the highest bid appearing first in a search list on the users PC (personal computer) screen. U.S. Pat. No. 6,269,361 describes such a bidding methodology.

Users enter key search words to perform a search and the search engine provides a list of search results in the form of links to web sites. One of the drawbacks of current search engines is that they typically do not take into consideration any information about the user to provide a better search result that is more pertinent to the user's interests. A search engine may simply “know” that users who have searched for “A” have also searched for “X”, “Y”, and “Z”. Searching today provides mostly sterile and often static listings of URL's that point to sites based on a Boolean search. Results often lack any real relevancy and often, users have to refine and refine to finally get what they are looking for.

Internet radio stations provide programming content and allow advertisers to provide “pop-up” icons that a user can click on to go to the web sites of the advertisers. Internet radio stations often require users to subscribe to the radio station in order to access programming content of the radio station. The subscription usually involves paying a fee. When a user accesses an Internet radio station, a commercial media player on the user's personal computer is typically launched in order to play streaming digital audio from the Internet radio station. Some Internet radio stations also broadcast through access providers, such as America Online (AOL) or the like, which requires a subscription. Thus, the users of the site pay a fee in order to access programming content of the radio station.

In a mobile environment, such as an automobile, access to media programming content has been largely limited to traditional broadcast radio, public radio, and satellite radio.

Further limitations and disadvantages of conventional, traditional, and proposed approaches will become apparent to one of skill in the art, through comparison of such systems with the present invention as set forth in the remainder of the present application with reference to the drawings.

### BRIEF SUMMARY OF THE INVENTION

An embodiment of the present invention comprises a method to access and use, from a mobile environment, an integrated web site. The method comprises communicating at least a first voice-activated command, using a voice recognition capability of a wireless mobile network (WMN) terminal, to access the integrated web site via a wireless communication network and a global informational network. The integrated web site comprises a network-based media station integrated with a global search engine. The method further comprises communicating at least a second voice-activated command, using the voice recognition capability of the WMN terminal, to the integrated web site via the wireless communication network and the global informational network in order to initiate transmission of streaming digital media content from the network-based media station to the WMN terminal. The method also includes communicating at least a third voice-activated command, using the voice recognition capability of the WMN terminal, to the integrated web site via the wireless communication network and the global informational network in order to initiate a key word search of the global informational network using the global search engine without interrupting the transmission of the streaming digital media content to the WMN terminal.

These and other advantages and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a schematic block diagram illustrating an embodiment of a system to access and use an integrated web site from a mobile environment, in accordance with various aspects of the present invention.

FIG. 2 is a flowchart of an embodiment of a method to access and use an integrated web site from a mobile environment using the system of FIG. 1, in accordance with various aspects of the present invention.

FIG. 3 is a schematic block diagram illustrating an embodiment of a wireless mobile network (WMN) terminal used in the system of FIG. 1 and the method of FIG. 2, in accordance with various aspects of the present invention.

FIGS. 4-5 illustrate several exemplary embodiments of possible mobile search player views, in accordance with various aspects of the present invention.

### DETAILED DESCRIPTION OF THE INVENTION

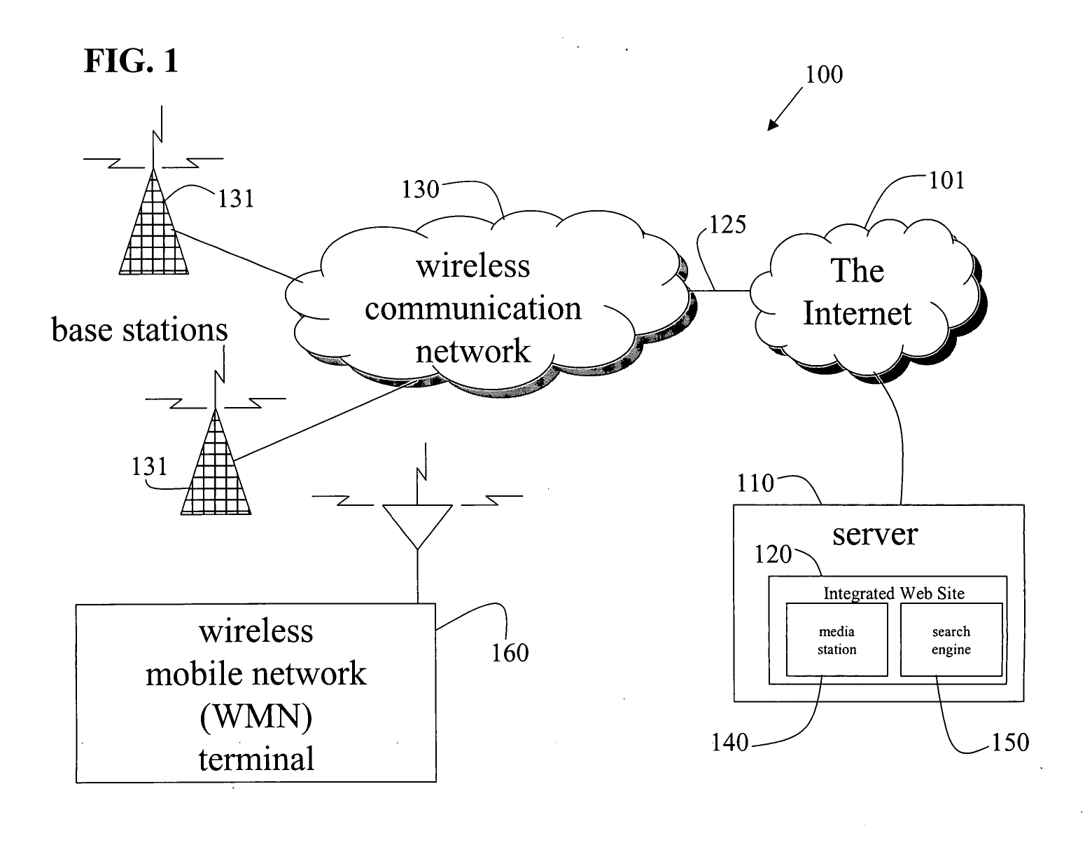

FIG. 1 is a schematic block diagram illustrating an embodiment of a system 100 to access and use an integrated web site 120 from a mobile environment, in accordance with various aspects of the present invention. The system 100 comprises a global informational network 101 (e.g., the Internet) and at least one server 110. The server 110 interfaces to the Internet 101. The system 100 further comprises a wireless communication network 130 which connects to the Internet 101. The connection 125 between the wireless communication network 130 and the Internet 101 includes a gateway which provides communication translation between the wireless communication network 130 and the Internet 101. The wireless communication network 130 includes RF (radio frequency) base stations 131. The system 100 also includes a wireless mobile network (WMN) terminal 160 which communicates wirelessly with the RF base stations 131.

In this embodiment, the WMN terminal 160 exists in a mobile environment such as an automobile, or via a cell phone or PDA. The WMN may be, for example, installed in an automobile or may be a handheld device. The RF base stations 131 are geographically spaced such that a user of the WMN terminal 160 can access the server 110 via the wireless communication network 130 and the Internet 101 as the user travels throughout a geographic area with the WMN terminal 160. For example, the RF base stations 131 comprise cellular telephone towers and the wireless communication network 130 comprises a cellular telephone network.

The server 110 hosts an integrated web site 120 which provides streaming digital media content and search capability, in accordance with various aspects of the present invention. The integrated web site 120 effectively integrates a network-based media station 140 with a global search engine 150. The integrated web site 120 is accessed using the WMN terminal 160 via the wireless communication network 130 and the Internet 101. Alternatively, the system 100 also includes a database and/or file storage device interfacing to the server 110. Such a database or file storage device may be used to store media files (e.g., MP3 files) or other information that can be downloaded to and stored on the WMN terminal 160. For example, a user may purchase and download certain MP3 files to create a stored playlist of music within the WMN terminal. As a result, the user can access the playlist and play the MP3 files without having to access the integrated web site 120 every time.

The present invention is not limited to the type of media consumed by the user, and although examples may relate to embodiments of Internet radio and the like, any other media consumed by users is contemplated herein. For example, a user may access media in the form of an on-line book or on-demand media, wherein the subject matter of the book, the author or other attributes of the material is used to provide search results according to the invention. Thus, a user may be accessing media at sites like Amazon.com or the like, and the concepts of the invention implemented to provide search information to the user according to the invention. Alternatively, the user may access media via a site such as Encarta.com, wherein the user may access media via the on-line encyclopedia, and the media used to provide search results according to the invention. For example, the user may view of photograph of the Mona Lisa, with search results generated according to the invention to provide information on the artist, period of other aspects related to this content. Thus, as should be evident, any type of media consumed by a user is contemplated in the invention.

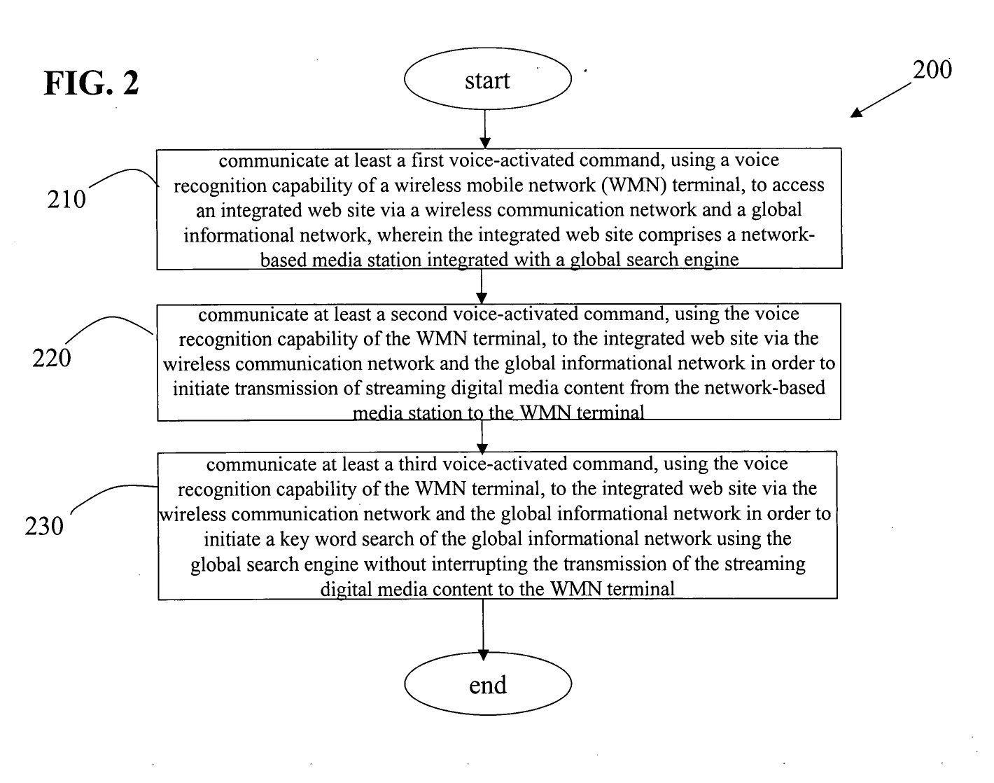

FIG. 2 is a flowchart of an embodiment of a method 200 to access and use an integrated web site 120 from a mobile environment using the system 100 of FIG. 1, in accordance with various aspects of the present invention. In step 210, at least a first voice-activated command is communicated, using a voice recognition capability of a WMN terminal, to access an integrated web site via a wireless communication network and a global informational network, wherein the integrated web site comprises a network-based media station integrated with a global search engine. In step 220, at least a second voice-activated command is communicated, using the voice recognition capability of the WMN terminal, to the integrated web site via the wireless communication network and the global informational network in order to initiate transmission of streaming digital media content from the network-based media station to the WMN terminal. In step 230, at least a third voice-activated command is communicated, using the voice recognition capability of the WMN terminal, to the integrated web site via the wireless communication network and the global informational network in order to initiate a key word search of the global informational network using the global search engine without interrupting the transmission of the streaming digital media content to the WMN terminal.

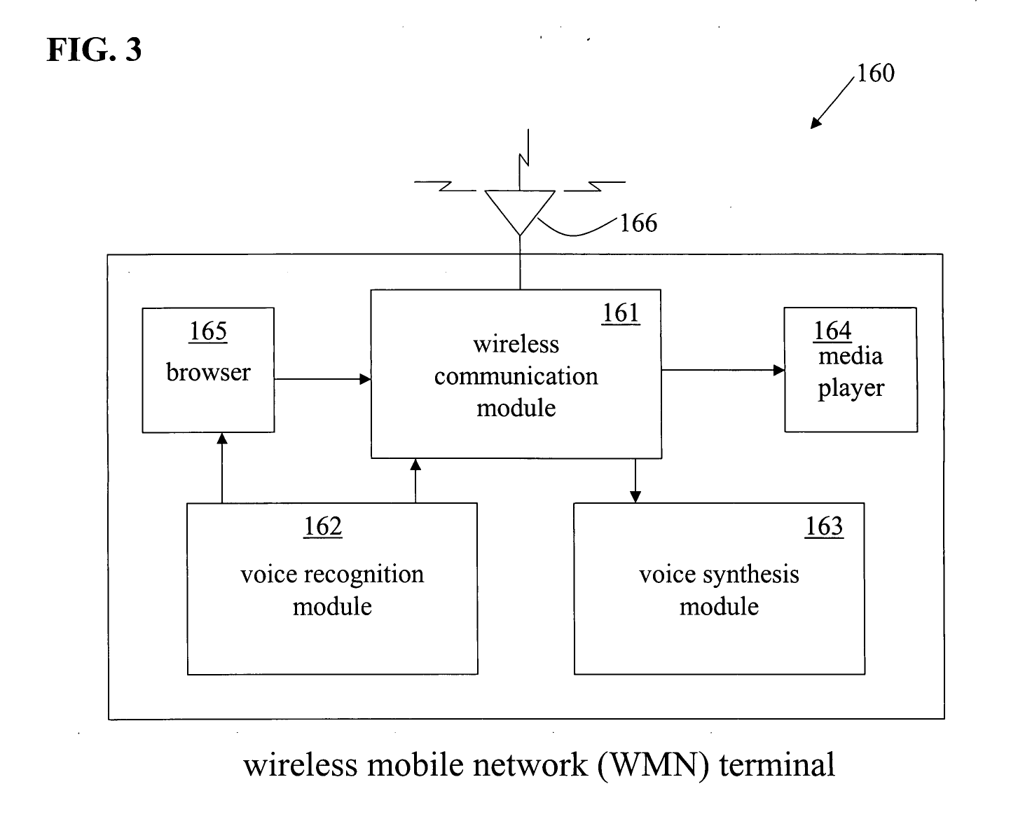

FIG. 3 illustrates an embodiment of a wireless mobile network (WMN) terminal 160 used in the system 100 of FIG. 1 and the method 200 of FIG. 2, in accordance with various aspects of the present invention. The WMN terminal 160 comprises a wireless communication module 161, a voice recognition module 162, a voice synthesis module 163, a media player module 164, a browser 165, and an RF antenna 166.

The voice recognition module 162 is communicably connected to (i.e., is in communication with) the wireless communication module 161 and the browser 165. The browser 165 is communicably connected to the wireless communication module 161. The voice synthesis module 163 is communicably connected to the wireless communication module 161. The media player module 164 is communicably connected to the wireless communication module 161. The RF antenna 166 is connected to the wireless communication module 161.

The various modules of the WMN terminal 160 include software and processing capability in order to execute the functionality of the modules. For example, the media player module 164 comprises a software application running on a processor and the browser 165 comprises another software application running on a processor.

In an embodiment, the wireless communication module 161 transmits and receives RF digital information. RF digital information is transmitted/received to/from the base stations 131. Details of how a WMN terminal communicates with a server via a wireless communication network and the Internet are discussed in U.S. Patent Application publication number US 2001/0011302 which is incorporated herein by reference in its entirety.

In this embodiment, the voice recognition module 162 receives audio (e.g., speech, voice) commands from a user of the WMN terminal and translates the audio commands into digital data commands (i.e., voice-activated commands). The digital data commands are communicated to the browser 165 and/or wireless communication module 161 in order to access and use the integrated web site 120 via the wireless communication network 130 and the Internet 101 (i.e., global informational network 101).

Alternatively, the voice synthesis module 163 receives digital information from the wireless communication module 161 and translates the digital information into audible speech which can be recognized by the user of the WMN terminal 160. The digital information originates at the integrated web site 120 and is communicated to the wireless communication module 161 via the Internet 101 and the wireless communication network 130.

In accordance with various alternative embodiments of the present invention, the various modules and communication paths within the WMN terminal 160 may be combined and/or further separated, based on various design choices.

For example, in accordance with an embodiment of the present invention, the WMN terminal comprises a laptop personal computer (PC) including the functionality provided by the various modules of the WMN terminal 160 of FIG. 3. In accordance with another embodiment of the present invention, the WMN terminal comprises a cellular telephone including the functionality provided by the various modules of the WMN terminal 160 of FIG. 3. In accordance with still another embodiment of the present invention, the WMN terminal comprises a personal digital assistant (PDA) including the functionality provided by the various modules of the WMN terminal 160 of FIG. 3. Other embodiments are possible as well.

In the invention, the integrated web site 120 may be hosted on the server 110 on the Internet 101 and is configured as an Internet radio station 140 that provides various streaming digital media content (such as, for example, music) as well as other information to the WMN terminal 160 via the established wireless and Internet network connections.

The integrated web site 120 may also comprise an integrated search engine 150. Further, the Internet 101 may instead comprise some other global informational network. In general, streaming digital media content comprises at least one of streaming digital audio or streaming digital video in the form of, for example, musical pieces (e.g. songs), human discourse (e.g., talk radio), television programs, music videos, news programs, etc.

For example, when a user selects a “media program content” link, streaming digital media content is routed from the server 110 to the WMN terminal 160 via the Internet 101 and wireless communication network 130. The media player 164 is automatically launched within the WMN terminal 160 and receives and plays the streaming digital media content (e.g., a musical piece) through speakers (not shown) within the WMN terminal 160 or through headphones (not shown) connected to the WMN terminal 160.

The “media program content” link choices include, for example, links to individual musical pieces or songs, an album of musical pieces or songs, songs of a particular artist, a category or genre of musical pieces or songs, talk radio shows, news, etc. For example, a first media program content link is the category of music called “Classic Rock”. When a user selects the “Classic Rock” category, streaming digital audio of classic rock music is transmitted from the server 110 to the WMN terminal 160. Alternatively, when a user selects the “Classic Rock” category, another set of links is presented to the user which provides choices of individual musical artists that the user may select. Other arrangements are possible as well, in accordance with various embodiments of the present invention.

A user may select any of the link choices and submit key search words to perform a search on the Internet 101. In an example, at least the entire World Wide Web (WWW) is available for searching via the voice recognition module 162 of the WMN terminal 160 using the search engine 150.

In accordance with an embodiment of the present invention, the user may search the Internet 101 using the search engine 250 while listening to the streaming digital media program content without interrupting the streaming digital media program content. The user may proceed to submit key search words in order to look for other web sites on the Internet 101. The web sites that a user may search for may include many different types of web sites that are hosted on the Internet 101, including web sites of advertisers who are sponsors of the Internet radio station.

The WMN terminal 160 facilitates accessing the integrated web site 120, initiating the streaming of digital media content to the WMN terminal 160, searching the Internet 101, and accessing various links provided by the integrated web site 120. In a further embodiment, various voice-activated commands are accepted by the voice recognition module 162 in order to access and use the integrated web site 120. For example, the command “Login” is used to establish a connection to the server 110 and access the integrated web site 120. The command “Search” is used to access the search engine 150. Subsequently, a key search word (or several key search words) is spoken to initiate an Internet search using the key search word(s). The commands “Music” and “Country” may be spoken to initiate the streaming of digital country music content to the WMN terminal 160. Similarly, the command “Link to Artist” may be spoken to receive information about the artist of the current country music song that is being streamed to the WMN terminal.

When certain information is provided to the WMN terminal 160 from the integrated web site 120, the voice synthesis module 163 is used to communicate the information to the user. The voice synthesis module 163 receives information in digital form and converts the information to audible speech which is recognizable by the user. The information communicated through the voice synthesis module 163 includes information that may or may not induce an audible response from the user using the voice recognition module 162.

For example, the integrated web site 120 may send a plurality of link choices to the WMN terminal 163 which are communicated to the user via the voice synthesis module 163. For example, the link choices may include “get directions”, “get local weather forecast”, and “buy CD”. The user then says “Link to get directions” which takes the user to a web site that will allow the user to give a current location and a destination location using the voice recognition module 162. The directions between the two locations are then audibly given to the user via the voice synthesis module 163. During the entire exchange, streaming digital media content is provided in an uninterrupted manner to the WMN terminal and is played by the media player module 164.

Alternatively, the integrated web site 120 may also provides a directory of commercial advertisements that a user of the WMN terminal may access and hear. The commercial advertisements take the form of streaming digital audio and promote products and/or services of the entity providing or sponsoring the integrated web site 120.

In the example of an Internet radio site, a radio announcer for the Internet radio station periodically encourages the user to select link choices provided and/or perform searches using the search engine 150 provided by the integrated web site 120.

Instead of an Internet radio station, the integrated web site 120 may provide an Internet television station, broadcasting streaming video and audio over parts of the Internet 101 and wireless communication network 130 that provide enough bandwidth to accommodate the video and audio programming. The Internet television station operates in a similar manner to an Internet radio station (i.e., providing a search capability and link choices). A display connected to the WMN terminal 160 can be used to view the Internet television station programming content. Such a mobile configuration in, for example, a family mini-van would provide viewable entertainment for passengers such as children. The television programming content includes, for example, news video clips or television shows.

As another alternative embodiment, the integrated web site 120 provides a media player and/or a web browser that can be downloaded to the user's WMN terminal via the Internet 101 and the wireless communication network 130. Once downloaded, the media player is then used to play the streaming digital media program content and the web browser is used to access links and to search using the search engine 150 on the integrated web site 120.

Additionally, the various components of the integrated web site 120 (e.g., the media station 140, the search engine 150, and other associated web pages) may be hosted on more than one server.

In accordance with an embodiment of the present invention, the global search engine 150 is provided by the provider of the integrated web site 120 as part of the integrated web site 120. However, the integrated web site 120 also provides the option of direct access to other search engines (e.g., Google™, Yahoo®) as well.

Other user interfaces are also contemplated, other than or in addition to voice activation, are possible. For example, touchscreen technology or simple push-button technology may be integrated into the WMN terminal 160 to allow a user to make selections and respond to cues.

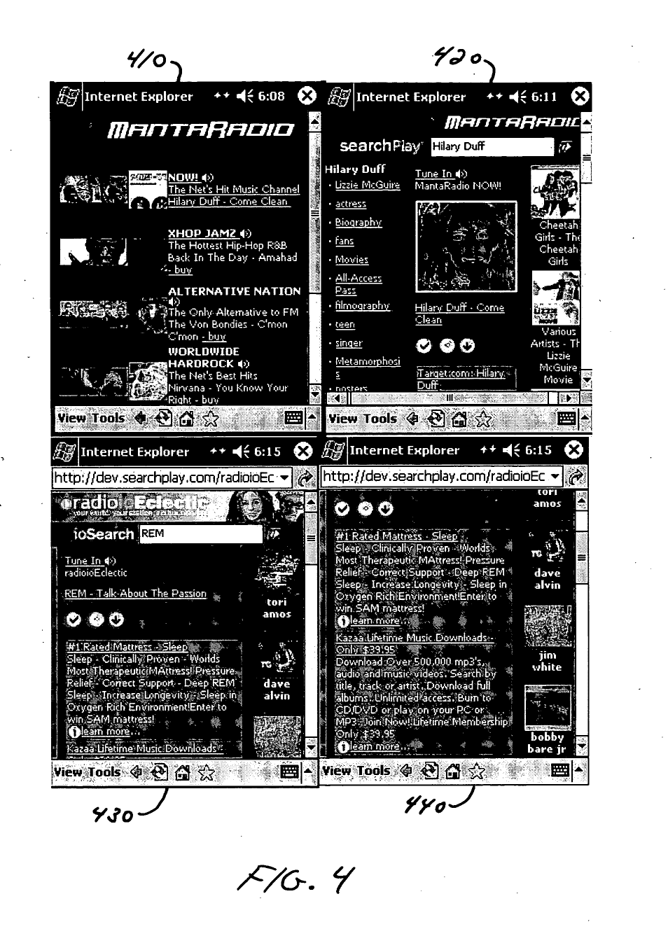

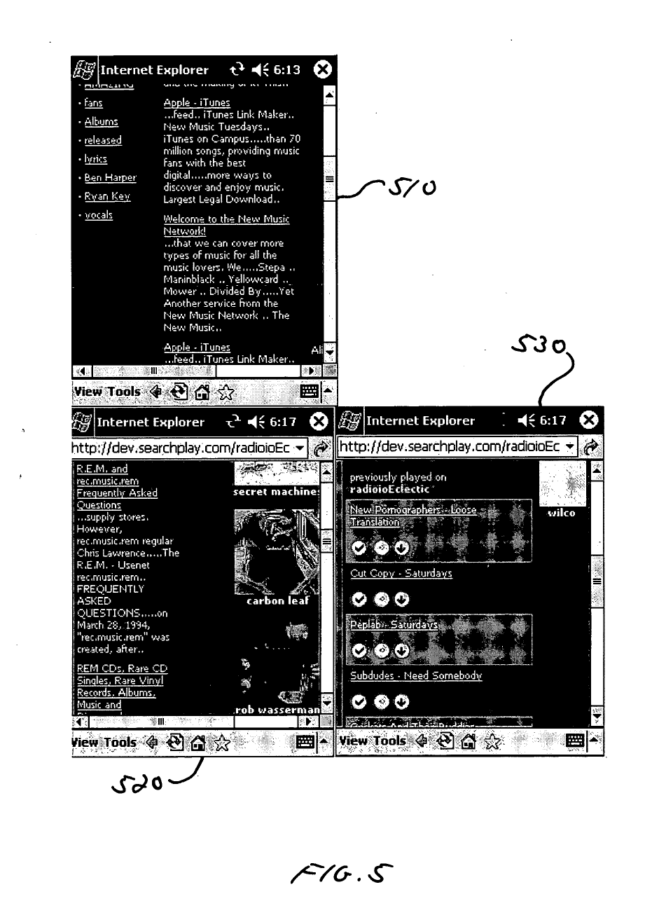

In accordance with an embodiment, the WMN terminal 160 includes a display for displaying a search player user interface view to the user. FIGS. 4-5 illustrate several exemplary embodiments of possible search player views (410-440 and 510-530), in accordance with various aspects of the present invention. These search player views include various links, key words, and other information that may be accessed by the user in the mobile environment either through, for example, voice activation methods or other methods as described herein.

Alternatively, the integrated web site 120 may provide a search player user interface to the WMN terminal with an embedded media player object for playing streaming digital media. A media player object is embedded into a frame-less pop-up window and is provided by the provider of the Internet radio station from the server 110. HTML is used to show the “now playing” information and the search view information in the pop-up window. The embedded media player object is used to play the stream of digital media data in any one of, for example, three selectable formats including QuickTime, real or MP3, or Windows Media. Each selectable format includes its own stream controls which are displayed near the bottom of the pop-up user interface view. The user selects which media player to have embedded and a user interface view is provided to the user which includes a navigation tool near the top of the user interface view, a populated search/play area which includes populated links based on a pre-search which was performed by the search engine using, for example, ID3/ID4 tag data. A separate media player is not needed on the user's WMN. The user interface view constitutes a search player which is a graphical image which has a media player built-in such that the embedded media player allows consumption of the media.

In summary, an integrated web site that is accessible via a wireless communication network and a global informational network using a wireless mobile network terminal provides voice-activated streaming digital media content, search capability, and link choices to other web pages and web sites.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A method to access and use, from a mobile environment, an integrated web site, said method comprising:
communicating at least a first voice-activated command, using a voice recognition capability of a wireless mobile network (WMN) terminal, to access said integrated web site via a wireless communication network and a global informational network, wherein said integrated web site comprises a network-based media station integrated with a global search engine;
communicating at least a second voice-activated command, using said voice recognition capability of said WMN terminal, to said integrated web site via said wireless communication network and said global informational network in order to initiate transmission of streaming digital media content from said network-based media station to said WMN terminal; and
communicating at least a third voice-activated command, using said voice recognition capability of said WMN terminal, to said integrated web site via said wireless communication network and said global informational network in order to initiate a key word search of said global informational network using said global search engine without interrupting said transmission of said streaming digital media content to said WMN terminal.

2. The method of claim 1 further comprising communicating at least a fourth voice-activated command, using said voice recognition capability of said WMN terminal, to said integrated web site via said wireless communication network and said global informational network in order to select a link provided by said integrated web site without interrupting said transmission of said streaming digital media content to said WMN terminal.

3. The method of claim 1 further comprising:
receiving, at said WMN terminal, said streaming digital media content from said network-based media station via said global informational network and said wireless communication network; and
playing said streaming digital media content using said WMN terminal.

4. The method of claim 1 further comprising:
receiving, at said WMN terminal, results of said key word search from said integrated web site via said global informational network and said wireless communication network; and
communicating said results of said search to a user of said WMN terminal via a voice synthesis capability provided by said WMN terminal.

5. The method of claim 2 further comprising:
receiving information, at said WMN terminal, from said integrated web site via said global informational network and said wireless communication network, as a result of selecting said link; and
communicating said information to a user of said WMN terminal via a voice synthesis capability provided by said WMN terminal.

6. The method of claim 1 wherein said global informational network comprises the Internet.

7. The method of claim 1 wherein said integrated web site is hosted on at least one server connected to said global informational network.

8. The method of claim 1 wherein said WMN terminal includes a media player software application which is automatically launched in order to play said streaming digital media content on said WMN terminal.

9. The method of claim 1 wherein said integrated web site includes a downloadable media player software application for playing said streaming digital media content on said WMN terminal.

10. The method of claim 1 wherein said streaming digital media content comprises at least one of streaming digital audio and streaming digital video.

11. The method of claim 1 wherein said network-based media station comprises an Internet radio station.

12. The method of claim 1 wherein said network-based media station comprises an Internet television station.

13. The method of claim 1 wherein said WMN terminal includes a browser software application to allow access to at least said integrated web site on said global informational network.

14. The method of claim 1 wherein said WMN terminal is installed and used in an automobile.

15. The method of claim 1 wherein said WMN terminal comprises a battery-operated, hand-held device.

16. The method of claim 2 wherein an availability of said link for selection is communicated to a user of said WMN terminal via a voice synthesis capability provided by said WMN terminal without interrupting said transmission of said streaming digital media content to said WMN terminal.

17. The method of claim 1 further comprising communicating at least a fourth voice-activated command, using said voice recognition capability of said WMN terminal, to said integrated web site via said wireless communication network and said global informational network in order to download at least one media file from said integrated web site to said WMN terminal without interrupting said transmission of said streaming digital media content to said WMN terminal.

18. The method of claim 17 further comprising:
receiving, at said WMN terminal, said at least one media file from said integrated web site via said global informational network and said wireless communication network;
storing said at least one media file on said WMN terminal; and
playing said at least one media file using said WMN terminal.

19. The method of claim 17 wherein said at least one media file comprises at least one music file in an MP3 data format.
